(19) United States
(12) Patent Application Publication
(10) Pub. No.: US 2008/0219211 A1
(43) Pub. Date: Sep. 11, 2008

(54) Frequency Domain Direct Sequence Spread Spectrum with Flexible Time Frequency Code

(76) Inventors: Michael R. Franceschini, Centerport, NY (US); Martin A. Stern, Fort Wayne, IN (US)

Correspondence Address: STRATEGIC PATENTS P.C.., C/O PORTFOLIOIP, P.O. BOX 52050, MINNEAPOLIS, MN, 55402, US

(21) Appl. No.: 12/116,863

(22) Filed: May 7, 2008

Related U.S. Application Data
(62) Division of application No. 09/802,280, filed on Mar. 8, 2001.
(60) Provisional application No. 60/188,084, filed on Mar. 9, 2000.

(51) Int. Cl. H04Q 11/00

(52) U.S. Cl. 370/330

(57) ABSTRACT

A spread spectrum radio frequency communication system includes a Forward Error Correction (FEC) algorithm to encode digital data to provide a plurality of symbol groups, the FEC algorithm using a Reed Solomon FEC code, an interleaving algorithm to map each one of the plurality of symbol groups into a corresponding one of a plurality of coherent subbands, and a Walsh encoder to encode each one of the plurality of symbol groups.

### CROSS-REFERENCE TO RELATED APPLICATIONS

This application is a divisional of U.S. application Ser. No. 09/802,280 filed on Mar. 8, 2001, which claims the benefit of U.S. Prov. App. No. 60/188,084 filed on Mar. 9, 2000. Each of these applications is incorporated herein by reference in its entirety.

### FIELD OF INVENTION

This invention relates generally to communication systems and more particularly to systems and techniques to reduce the effects of heavy absorption of direct signal path propagation and the effects of multipath.

### BACKGROUND OF INVENTION

Modern communication requirements demand reliable and timely communications in highly restrictive terrain and in severe multipath fading conditions found both inside buildings and outside in urban areas. Wireless or mobile radio communications suffer severe degradations in performance in restrictive terrain, such is in urban environments and within buildings. This is typically due to heavy absorption of the direct path signal energy combined with significantly strong specular multipath bounces (i.e. bounces off of discrete objects such as buildings and walls). The multipath signals cause in-band fading that reduces the signal energy in small fragments of spectrum at a time, while other frequency components may be unfaded, or even enhanced by added multipath energy. For narrowband signals, this means that a desired receive frequency may be attenuated beyond use and rendered unrecoverable, unless excessive transmitter power is used to provide tens of dB of fade margin. For wideband signals, unfaded segments of the band may have enough residual signal energy to make up for the lost energy in the faded segments, making reception possible, however, severe distortion (intersymbol interference, amplitude/phase dispersion, etc.) still makes receiver recovery a difficult signal processing challenge.

The traditional approach to solving the frequency selective multipath fading problem is either to use frequency diversity such as transmitting on more than one frequency and use multiple receivers, but this is expensive, wasteful of spectrum, and if both channels are faded will still fail, or to use a wideband signal format that spans wider than frequency selective fades. The latter is the preferred state-of-practice, such as for spread spectrum CDMA/PCS cellular techniques. A newer OFDM (Orthogonal Frequency Division Multiplexing) signal format is also being explored, such as by European commercial HDTV developers, that processes each of many parallel frequencies independently such that unfaded signals are processed cleanly in an undistorted narrow coherent bandwidth, and frequency selective faded frequencies are discarded. Redundancy is used to recover the information lost in discarded frequencies.

Multi-Carrier Modulation (MCM) is a technique of transmitting data by dividing the stream into several parallel bit streams, each of which has a much lower bit rate, and by using these substreams to modulate several carriers. Orthogonal Frequency Division Multiplexing (OFDM), a special form of MCM with densely spaced subcarriers and overlapping spectra is described in U.S. Pat. No. 3,488,445 and issued in Jan. 6, 1970. OFDM abandoned the use of steep bandpass filters that completely separated the spectrum of individual subcarriers, as it was common practice in older Frequency Division Multiplex (FDMA) systems, in Multi-Tone telephone modems and as used in Frequency Division Multiple Access radio. OFDM time-domain waveforms are chosen such that mutual orthogonality is ensured even though subcarrier spectra may overlap. Such waveforms can be generated using a Fast Fourier Transform at the transmitter and receiver.

It has been learned from earlier experiments with wireless data transmission that the selection of the modulation technique is highly critical. In the early days of mobile communications, many attempts to connect a telephone modem to a cellular phone failed because of mobile channel anomalies. With the demand for wireless data communications, experiments and product tests revealed that mobile fading channel needed specific solutions for the modulation technique, bit rate, packet length and other aspects. In conventional modulation techniques, dispersion (as described in terms of a channel delay spread and intersymbol interference) reduces the maximum achievable rate. Equalization can mitigate this to some extent, but typically at the cost of increased noise, so it leads to a transmit power tradeoff or an increased vulnerability to interference. Alternatively, several results showed that with a well-designed Coded OFDM system, modest dispersion can improve, rather than deteriorate, the bit error rate. If the entire MCM signal is subject to flat fading, i.e., if all subcarriers experience the same fading, bit errors occur on subcarriers are highly correlated. Error correction with code words spread across subcarriers may not be able to correct erased or wrong bits. In a channel with a larger delay spread, the coherence bandwidth can be such that fading only affects a limited number of subcarriers at a time. Forward error correction coding can successfully repair poor reception at those subcarriers. Interleaving in frequency domain, i.e., across subcarriers can be used to further improve the performance. Signals from different applications or programs are interleaved to achieve greater independence of fading of subcarriers for individual user data streams.

Additionally, frequency dispersion also called doppler spreading can be caused by delay spreads in the multipath channel. If the symbol duration is relatively large, it is unlikely that the symbol energy completely vanishes during signal fade. However, OFDM subcarriers loose their mutual orthogonality if rapid time variations of the channel occur, which typically leads to increased bit error rates. Similarly, phase jitter or receiver frequency offsets also leads to interchannel interference. This sensitivity to frequency offsets, as well as to nonlinear amplification is often attributed to be one of major MCM disadvantages. A time-varying frequency error not only erodes the subcarrier orthogonality, but also makes subcarrier synchronization much more difficult to achieve and maintain.

The use of Fourier transforms in both the transmitter and receiver, allows MCM communication systems to reduce the effects of time dispersion and the effects of frequency dispersion. A maximum-length linear feedback shift register sequence can be used to find the delay profile of a time dispersive, i.e., frequency selective channel. If such a sequence is transmitted in multi-carrier format, i.e., after Fourier Transformation, it can be used to find the Doppler components of the frequency dispersive channel. In a mobile multipath channel, signal waves coming from different paths often exhibit different Doppler shifts. A MCM receiver can detect the individual components by searching shifted versions of the sequence at the output pins of the FFT. The resulting correlation pattern can be used to steer the local oscillator to better track the signal.

OFDM generally uses fixed sub-bands and pilot/tracking/traffic channel formats with no spectrum spreading for either CDMA frequency re-use benefits or for low probability of intercept/antijam (LPI/AJ) processing gain needed for military applications. It is therefore desirable to provide an improved modulation technique to reduce the effects of heavy absorption of direct signal path propagation and the effects of multipath.

### SUMMARY

In accordance with the present invention, a method of providing a spread spectrum radio frequency communication signal includes the steps of forming a stream of data into a plurality of data packets and embedding each data packet into a physical layer packet including the steps of adding a packet header, performing a cyclic redundancy check and encoding the data. The encoding the data step includes the steps of encoding digital data with a Reed Solomon forward error correction algorithm to provide RS symbols and interleaving the RS symbols across a plurality of coherent subbands. The method further includes the step of encoding each interleaved RS symbol with a low rate Walsh code. With such a technique, spread spectrum bandwidth is divided into coherent subbands and forward error correction (FEC) is used to erase symbols transmitted on faded or jammed subbands and to correct symbols transmitted on faded subbands with high subband error rates.

In accordance with a further aspect of the present invention, a spread spectrum radio frequency communication system includes a Forward Error Correction (FEC) algorithm to encode digital data to provide a plurality of symbol groups, the FEC algorithm using a Reed Solomon or a Turbo Code FEC code and an interleaving algorithm to map each one of the plurality of symbol groups into a corresponding one of a plurality of coherent subbands, and a Walsh encoder to encode each one of the plurality of symbol groups. With such an arrangement, multiple subbands contain partially redundant information such that many subbands can be lost and the information can still be regenerated.

The system further includes a transmission security device to encrypt each one of the Walsh encoded symbol groups and an Inverse Fast Fourier Transform (IFFT) coupled to the transmission security device. With such an arrangement, additional security can be provided as required by military systems with the advantages of the present invention.

### BRIEF DESCRIPTION OF THE FIGURES

The foregoing features of this invention, as well as the invention itself, may be more fully understood from the following description of the drawings in which:

FIG. 1 is a block diagram of a spread spectrum radio frequency communication system according to the invention;

FIG. 1A is a plot showing the frequency spectra of the various subbands implementing the technique according to the invention;

FIG. 2A is a block diagram of a modulator and a corresponding demodulator accordingly to the invention;

FIG. 2B is a block diagram of an alternative modulator and corresponding demodulator accordingly to the invention;

FIG. 2C is a more detailed block diagram of a modulator accordingly to the invention; and

FIG. 3 is a plot of Eb/NO required to achieve a given bit error rate for spread modulation.

### DETAILED DESCRIPTION

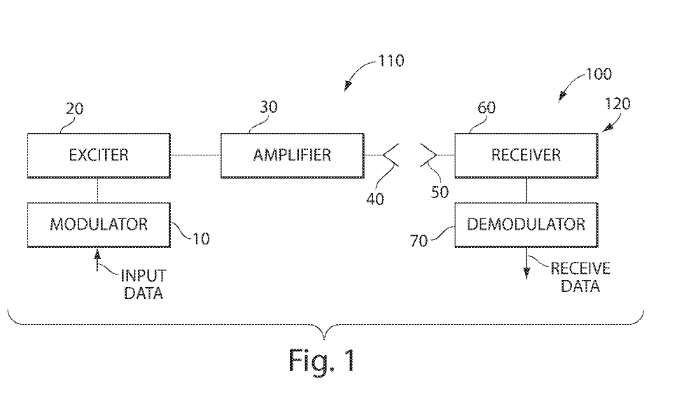

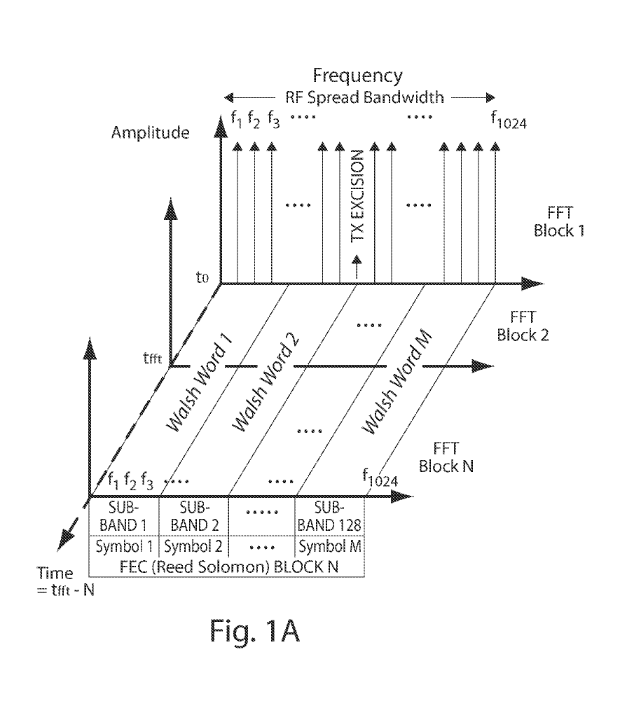

Referring now to FIG. 1, a spread spectrum radio frequency communication system 100 is shown to include a transmitter 110 and a receiver 120. The transmitter 110 includes a modulator 10 wherein an input data signal is encoded and modulated using a novel spread spectrum waveform as described hereinafter and a resulting modulated signal is fed to an exciter 20. The exciter 20 up converts the modulated signal to a transmit frequency signal and feeds the transmit frequency signal to an amplifier to increase the power of the signal. The output signal from the amplifier is then fed to an antenna 40 for propagating a transmit RF signal to the receiver 120. The transmit RF signal is captured by a receive antenna 50 which feeds a received signal to a receiver 60. The receiver 60 down converts the received signal to a baseband signal wherein the baseband signal is fed to the demodulator 70. The demodulator 70 then demodulates and decodes the baseband signal to an output data signal as described hereinafter.

The novel spread spectrum waveform is a type of Orthogonal Frequency Modulation (OFDM) waveform wherein an OFDM waveform is combined with a unique coherent subband coding including Walsh Orthogonal Codes and Reed Solomon forward error correction (FEC) to provide reliable communications. The technique incorporates both transmit and receive frequency excision and Reed Solomon symbol erasures (erasure decisions use side information provided by the Walsh decoder) to provide performance gains in narrow band interference.

Frequency division-sequence spectrum spreading (FD-DSS) resembles OFDM, except that the sub-bands are not narrowband fixed channels, but rather, flexible time-frequency channels that allow direct sequence spectrum spreading with large order M-ary coding across both dimensions simultaneously. Variable coherent integration times, bandwidths, M-ary alphabet sizes, data rates, and processing gains allow adaptive matching or selection of the most efficient signal format for the channel conditions (i.e. multipath, interference, jamming, etc.) encountered on each link in a decentralized changing network. Redundancy across sub-bands is provided by forward error correction (FEC) coding across subbands and a subband quality measure step detects and erases corrupted frequency sub-bands before FEC decoding. Faded subbands are de-emphasized (i.e. erased) in the decoding process, while the full information set is recovered from the surviving strong subbands, which may even be SNR enhanced by multipath. Rapid fast-convolution acquisition and self discovery affords immediate reception without equalizer/RAKE training for efficient burst-mode channel sharing operations in multi-terminal ad hoc networks.

Direct sequence spread spectrum applied across both time and frequency provides a gaussian amplitude distribution and suppressed cyclostationary feature waveform, that is virtually indistinguishable from gaussian noise, yielding excellent clandestine (LPI/LPD) communications. Spread spectrum processing gain spreads the information across a large transmission bandwidth reducing the power spectral density, and providing both LPI/AJ performance and the ability to perform CDMA channel sharing. Interference/jam resistance is further enhanced via narrowband excision of individual frequencies/subbands that are jammed by large intefererers.

FD-DSS modulation allows modifying the transmitted spectrum by inserting zero amplitude weights in any narrow-band frequency subset. This allows spectrum tailoring to fit any available frequency allocations, and improves co-site performance by virtue of both the transmit and receive excision of undesirable interference.

As described above, an OFDM waveform is essentially a multicarrier modulation technique where a large number of modulated carriers are transmitted simultaneously. The modulated carriers are separated in frequency so that they are orthogonal to one another. Examples of modulation used on the individual carriers in OFDM systems are BPSK, QPSK, and QAM. The total bandwidth taken up by all the carriers is the bandwidth of the OFDM waveform. The novel waveform is a spread spectrum waveform that is based on Orthogonal Frequency Division Modulation (OFDM). It utilizes 1024 carriers, with each carrier modulated with QPSK modulation. More generally, any number of carriers can be used, and each carrier may be modulated with M-PSK or M-QAM modulation.

In general, OFDM waveforms are modulated and demodulated using FFT algorithms. Since OFDM waveforms are a multicarrier modulation one might consider generating the modulation by independently generating the modulation on each carrier and then adding the waveforms together. For a large number of carriers this is not an efficient technique and a more efficient technique for generating the waveform uses FFTs. An array of complex number is used where each element in the array corresponds to one of the OFDM carrier frequencies. Each array element is filled with the complex value corresponding to the data imposed on the OFDM carrier represented by the array element. For example, if QPSK modulation is used on each carrier, then each element is filled with one of four complex values corresponding to the four QPSK phases. After the array is filled, an inverse FFT is performed. The resulting array is then the time domain representation of the data and is used as the waveform for transmission by the exciter 20. This process is then repeated again for each array element until the entire data packet is transmitted.

With a large enough number of carriers, mathematically the Central Limit Theorem implies the transmitted waveform takes on a Gaussian noise-like amplitude and phase distribution. The amplitude distribution is Rayleigh distributed and the phase distribution is uniformly distributed which is the same amplitude and phase distribution as additive white gaussian noise. In addition to the Gaussian noise like time domain signal, the power density across all the OFDM bandwidth is uniformly distributed so there is no distinguishing shape to the power spectral density of the waveform. Both these very desirable “featureless” properties distinguish the novel waveform. Traditional direct sequence waveforms do not possess these noise-like statistical properties, as well as dithered and filtered direct sequence waveforms fail to provide the uniform PSD and the noise-like amplitude distribution.

As an OFDM waveform, the novel waveform includes 1024 independent carriers across the signal bandwidth with each carrier transmitting QPSK modulation. All 1024 QPSK symbols on all 1024 carriers have the same symbol timing. All QPSK symbols on all the carriers are unshaped and therefore each symbol on a carrier includes a pure carrier in one of four phases for the entire symbol period. The frequency spacings of the carriers is the bandwidth divided by 1024. In a similar manner, the QPSK symbol rate for each carrier is the bandwidth divided by 1024. Thus for a 25.6 MHz bandwidth, the carrier spacing is 25 KHz and the QPSK symbol rate is 25 Ksps; for a 12.8 MHz bandwidth, the carrier spacing is 12.8 KHz and the QPSK symbol rate is 12.8 Ksps, and so on.

The novel OFDM waveform utilizes a unique approach to multipath mitigation that is optimized for a mobile packet network and does not have the training and convergence problems of other OFDM equalization techniques. The novel technique is based on subband coding where the spread bandwidth is divided into subbands and forward error correction (FEC) is used to erase symbols transmitted on faded or jammed subbands and to correct symbols transmitted on faded subbands with high subband error rates.

The 1024 carriers are grouped into coherent subbands of contiguous frequencies. The number of subbands are configurable and vary from a minimum of 32 subbands to a maximum of 256 subbands. The more subbands, the fewer frequencies within each subband such that with 32 subbands, the number of frequencies within the subband would equal 32, with 64 subbands, the number of frequencies within the subband would equal 16, with 128 subbands, the number of frequencies within the subband would equal 8 and with 256 subbands, the number of frequencies within the subband would equal four. In a highly urban environment, typically 32 subbands would be used. In a rural or airborne environment, typically 128 subbands would be used.

With a network that provides for various communication modes with different throughput rates, processing gains and link robustness, the basic waveform is parameterized so that it can be configured to match the requirements of a particular network link and the waveform can support bandwidths of 25.6 MHz, 12.8 MHz, 6.4 MHz, 3.2 MHz and 1 MHz.

The data to be transmitted is fed to a modem (not shown) which packetizes the data stream. Each data packet is then embedded into a physical layer packet which adds a packet header, performs a cyclic redundancy check (CRC) and encodes the data. The physical layer packet encoding utilizes two coding processes that are concatenated together. The first process encodes baseband data with a Reed Solomon (RS) FEC to provide RS symbols. The RS symbols are then interleaved across the subbands. The interleaving assures that only one RS symbol from any RS block is transmitted within any subband. The second coding process is a subband coding process that encodes the symbols transmitted within each subband. Subband coding is performed with low rate Walsh codes. Thus the RS symbols that have been interleaved within a subband are further encoded with a low rate Walsh orthogonal code.

The fundamental FD-DSS novel waveform utilizes a two dimensional time/frequency plane for data and spread spectrum chip modulation. FIG. 1A illustrates its signal space. Each data symbol occupies a time-bandwidth product that typically spans less than the entire allocated bandwidth (BW). The channel is partitioned into subbands, each with limited coherent integration bandwidth. Fitting the coherent BW bandwidth of the signal to no more than the channel supports is a key to achieving high multipath resistance. For HF that bandwidth may be only one KHz, at VHF maybe 100 KHz. In general, the emphasis is to integrate longer in time, but over shorter subbands. Thus, each subband becomes a single frequency bin, integrated over a full data bit time, but there is no spread spectrum processing gain across frequency.

Spread spectrum is the foundation of any LPI/AJ signal design and LPI specifically requires some DSS (not pure frequency hop) to decrease the power spectral density. But a wide bandwidth DSS signal (i.e. greater than one MHz) typically spans more than the coherent bandwidth supported by an HF/VHF channel, resulting in frequency selective in-chip fades and distortion. Subbands serve to isolate frequency selective fades to small enough entities such that subbands may be erased. FEC coding redundancy using a Reed-Solomon algorithm then recovers the data that was lost in any discarded subbands. Further this OFDM-like channel compensation is immediate, and does not required any learned knowledge of the channel. There is no training interval delay or overhead, as with adaptive channel equalization techniques. A receiver instantly compensates for any type of channel degradation.

FFT's enable frequency domain processing of parallel independent subbands. Equal resolution against fading and jamming interference of all cells is critical. The signal can be no more vulnerable to the loss of one given subband than to any other. Further, FFT's offer other significant benefits, such as a featureless gaussian noise-like waveform (truly high LPI), narrowband excision (vs. jamming and transmitter EMI), spectral shaping/masking, and rapid parallel-search acquisition (fast convolution) to enable non-blocking TDMA MACs Large-order M-ary orthogonal modulation, realized using Walsh functions (much like CDMA/PCS cellular), provides extremely efficient Eb/No performance against additive white Gaussian noise (AWGN), typically about 3.5 dB for M=1024 and BER=10.sup.5. Walsh functions are also particularly well suited for spread spectrum signals, since they already spread K bits into M=2 K chips in each M-ary symbol. A TRANSEC PN (pseudonoise sequence) overlay scrambles the Walsh words by modulo-2 addition to the M Walsh chips, protecting against enemy exploitation of the known Walsh code sets.

The combined Walsh/TRANSEC chip stream multiplies the phase coefficient of each FFT bin, impressing independent phase modulation upon each sub-carrier. The random phase difference across the channel creates a gaussian noise-like signal characteristic and it is virtually featureless against cyclostationary detectors. The time domain pattern is truly noise, and a constellation scatter diagram is a uniform cloud. There are no discernible high points in any distribution.

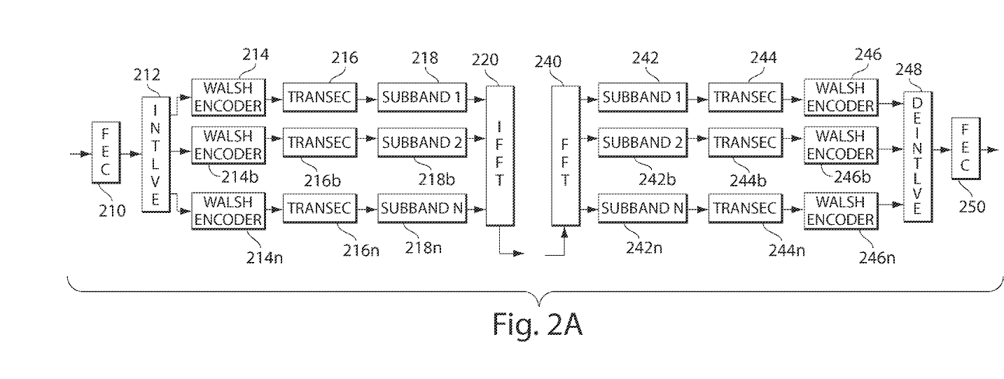

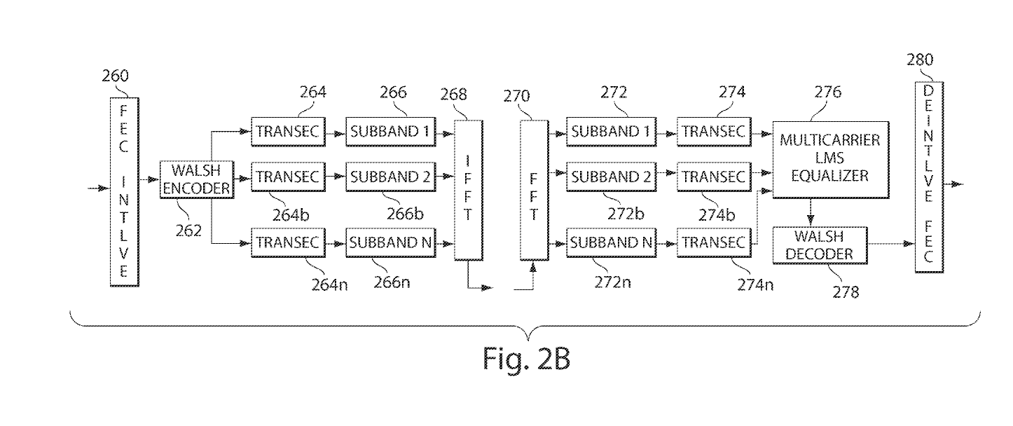

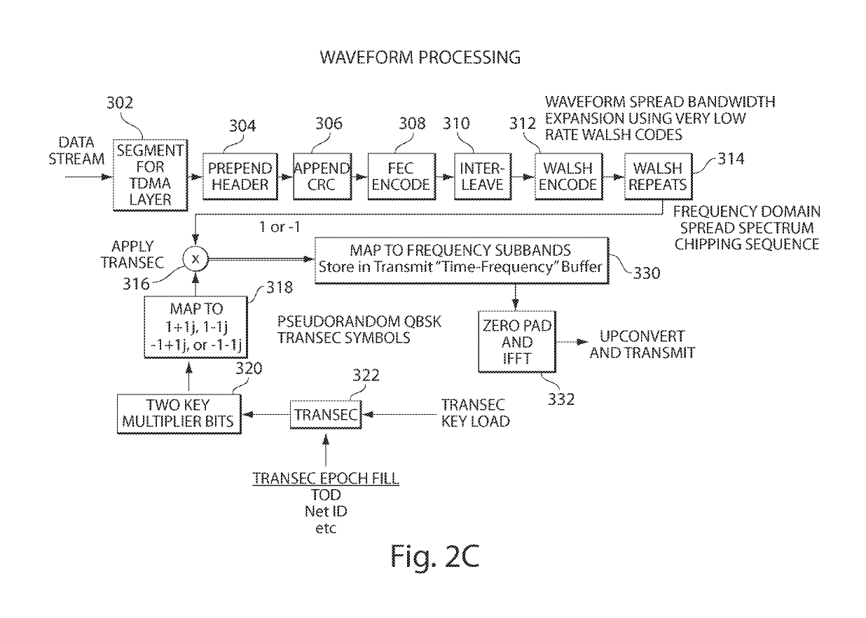

As with any modulation technique, transmission of information requires data to be impressed onto the FD-DSS modulation. Two techniques for impressing baseband data onto the subband modulation are illustrated in FIGS. 2A and 2B, respectively. The first technique requires no equalization and therefore requires neither equalizer convergence nor tracking. The second technique makes use of an adaptive equalizer and requires both equalizer convergence and tracking. In the first technique as shown in FIG. 2A, the digital data is encoded with a Forward Error Correction (FEC) code as shown by FEC block 210 prior to modulation, for example a Reed Solomon FEC code can be used. Alternatively, a Turbo Code, convolutional code, or other block FEC code could be used. The encoded data is optimally interleaved as shown by interleave block 212 across the subbands so that the FEC symbol N of any single code block are distributed uniformly across the subbands. After each block symbol is segmented into RS symbols, each segmented symbol is grouped into sets of N (N=8, 12, 16 or 24 depending on the mode) symbols and then each N symbol group is FEC encoded. A 32 symbol block, with 32 RS symbols, is then mapped into the subbands. With 32 subbands, we map the 32 symbols into the 32 subbands one to one. With 64 subbands, we map RS block 1 symbols into subbands 1, 3, 5, 7, etc. and map RS block 2 symbols into subbands 2, 4, 6, 8, etc. With 128 subbands, we map RS Block 1 symbols into subbands 1, 5, 9, etc., map RS block 2 symbols into subbands 2, 6, 10, etc., map RS block 3 symbols into subbands 3, 7, 11, etc. and map RS block 4 symbols into subbands 4, 8, 12, etc. and so forth for 256 subbands, etc. Optimally, no subband includes more than one FEC symbol from a code block. The loss of subbands to multipath fading, jamming, etc. is then recovered through the FEC decoding process. Any subband lost to fading or jamming eliminates at most one FEC symbol from any FEC code block so that as long as the number of lost subbands is less than the correction capability of the code, the transmitted data is recovered. Each subband has a corresponding Walsh encoder 214 wherein the interleaved RS signal is Walsh encoded in a known manner. The Walsh encoded RS signal is then encrypted by a transmission security device 216 and fed to subband filter 218. The output of the respective subband filters 218, 218b . . . 218n are fed to an Inverse Fast Fourier Transform (IFFT) 220 wherein the signal is fed to the exciter 20.

In the receiver 120, a received signal is fed to a Fast Fourier Transfer (FFT) 240 wherein the signal is divided into a plurality of subband signals which are fed to corresponding subband filters 242, 242b . . . 242n. Each one of the subband signals are decrypted by a transec device 244 and fed to a Walsh decoder 246. The signals are then de-interleaved as shown by block 248 and fed to forward error correction device 250. FEC decoding can be performed using soft output from the subband Walsh decoder allowing either full maximum likelihood soft inputs to the decoder or alternatively subband and symbol erasures.

As shown in FIG. 2B, the second technique transmits the same data on all or a portion of the subbands. With this technique data redundancy is obtained through the repeated data on all the subbands. In this embodiment, the digital data is encoded with a Forward Error Correction (FEC) code as shown by FEC block 260 using a Reed Solomon FEC code. The output is fed to a Walsh encoder 262 wherein the RS signal is Walsh encoded in a known manner. The Walsh encoded RS signal is then fed to each of the respective subband channels to be encrypted by a transmission security device 264 and then fed to subband filter 266. The output of the respective subband filters 266, 266b . . . 266n are fed to an Inverse Fast Fourier Transform (IFFT) 268 wherein the signal is fed to the exciter 20.

In this embodiment of the receiver 120, a received signal is fed to a Fast Fourier Transfer (FFT) 270 wherein the signal is divided into a plurality of subband signals which are fed to corresponding subband filters 272, 272b . . . 272n. Each one of the subband signals are decrypted by a transec device 274 and fed, via a multicarrier LMS equalizer 276, to a Walsh decoder 278. The signals are then fed to forward error correction device 280. FEC decoding can be performed using soft output from the subband Walsh decoder allowing either full maximum likelihood soft inputs to the decoder or alternatively subband and symbol erasures.

The received signal contains replicates of the data on each subband with more or less fidelity depending on the degree of fading or jamming on each individual subband. To recover the data, the data replicated on all the subbands are optimally combined weighting the data in each subband in proportion to the fidelity of the subband. This optimal combining of subbands is performed with an adaptive equalizer at the receiver such as a Least Mean Square equalizer, Viterbi equalizer or other linear or nonlinear equalizer.

It should be appreciated that subband mapping assures that only a single RS symbol from any RS block is mapped into a subband thus a faded or jammed subband destroys only a single RS symbol from any one RS block. As described, the first encoding process, RS encoding and interleaving across subbands is as follows. Each block symbol is segmented into, here 5, bit RS symbols. Next, each segmented symbol is grouped into sets of N (N=8, 12, 16 or 24 depending on the mode) symbols and then each N symbol group is FEC encoded. The 32 symbol block, with 32 RS symbols, is then mapped into the subbands. With 32 subbands, we map the 32 symbols into the 32 subbands one to one. With 64 subbands, we map RS block 1 symbols into subbands 1, 3, 5, 7, etc. and map RS block 2 symbols into subbands 2, 4, 6, 8, etc. With 128 subbands, we map RS Block 1 symbols into subbands 1, 5, 9, etc., map RS block 2 symbols into subbands 2, 6, 10, etc., map RS block 3 symbols into subbands 3, 7, 11, etc. and map RS block 4 symbols into subbands 4, 8, 12, etc. and so forth for 256 subbands, etc. This mapping of each RS block symbol into a different subband instead of the same subband provides the advantage of the present invention.

Each symbol from a RS block is transmitted on a unique subband, so that a faded or jammed subband interferes with at most one symbol from an FEC block. The process of interleaving RS symbols across subbands is a key factor to improving multipath fading capabilities of the waveform, because it assures that any faded or jammed subband will corrupt only a single RS symbol from an y RS Block. Of course, there are many RS symbols transmitted in each subband, but each RS block has at most one symbol residing in a subband. For example, in the 25.6 MHz, the bandwidth may be divided into 128 subbands. If a RS(32, 16) rate ½ FEC is used, then the symbols from a RS block are all placed in different subbands and are separated by 4 subbands from one another. For example, the 32 symbols from a RS block may be in the 32 subbands 1, 5, 9, 13 etc.

During demodulation, first the Walsh encoded data in each subband is decoded and then second, the decoded symbols from all the subbands are deinterleaved and RS decoded. The subband Walsh decoding process provides a quality measure of the decoded symbols in the subband Walsh word. The Walsh decoder can detect whether the subband cannot be reliably decoded such as when the subband is faded or jammed. This quality information is passed onto the RS decoder to aid in the second decoding step. If the quality measure is below a threshold, the RS decoder is told to “erase” the symbol residing in the Walsh word. This erasure process prevents errors from reaching the Reed Solomon decoder and significantly improves the performance of the RS decoder because the RS decoding algorithm performs better if it knows a symbol is unreliable. For example, an RS(32,16) FEC can correct up to 8 errors, but can fill in up to 16 erasures. The decoder's performance against a combination of errors and erasures improves as more errors are detected and converted to erasures. This means that with an RS(32, 16) FEC, up to half the subbands across the spread bandwidth can be faded or jammed and the waveform can still recover the transmitted data. Using a more powerful FEC such as an RS(32,8), up to ¾ of the subbands can be jammed or faded.

We will now describe how the novel waveform utilizes Walsh Coding to expand waveform bandwidth and to provide spread spectrum processing gain. Processing gain can be defined as the ratio of the waveform bandwidth to the information bit rate. Traditionally, direct sequence processing gain is achieved by mapping each data bit into a digital waveform made up of many pseudorandom channel bits. One common way of accomplishing this is as follows. For each data bit, a large number of pseudorandom channel bits are generated. If the data bit is “1” the pseudorandom sequence is left unchanged. If the data bit is a “0”, the pseudorandom sequence is inverted, that is “1” s are changed to “0” and “0” s are changed to “1”. For example, for each data bit, 100 pseudorandom channel bits may be generated and then transmitted. In this case, the bandwidth is increased by 100 yielding a 20 dB processing gain. On the channel, each chip might be used to modulate a BPSK modulation, or pairs of chips might be used to modulate a QPSK modulation. The bit error rate performance of such a system is that of QPSK. Of course forward error correction is almost always used to improve the performance beyond that of uncorrected QPSK.

It should be appreciated that a technique of achieving direct sequence processing gain, which is used in the novel waveform, is to spread using orthogonal sequences such as Walsh codes. Walsh codes are orthogonal codes that map “w” bits into 2 w chips, where w is an integer selected for the waveform operating mode. For example a 1024 chip Walsh encoder takes 10 bits and maps them into 1024 chips. Similarly a 32 chip Walsh encoder takes 5 bits and maps them into 32 chips. Different perating modes use different size Walsh codes. Typically 32, 1024, 2048 and 4096 chip Walsh codes are used in operating modes. Walsh coding provides processing gain because it expands the signal bandwidth. For example, if 1024 Walsh sequences are used then for each 10 bits of data, 1024 Walsh chips are transmitted, expanding the bandwidth 102.4 times. This provides a processing gain of 20. To achieve higher processing gains, longer Walsh Sequences can be used. Alternatively, processing gain can be increased by repeating each Walsh word many times.

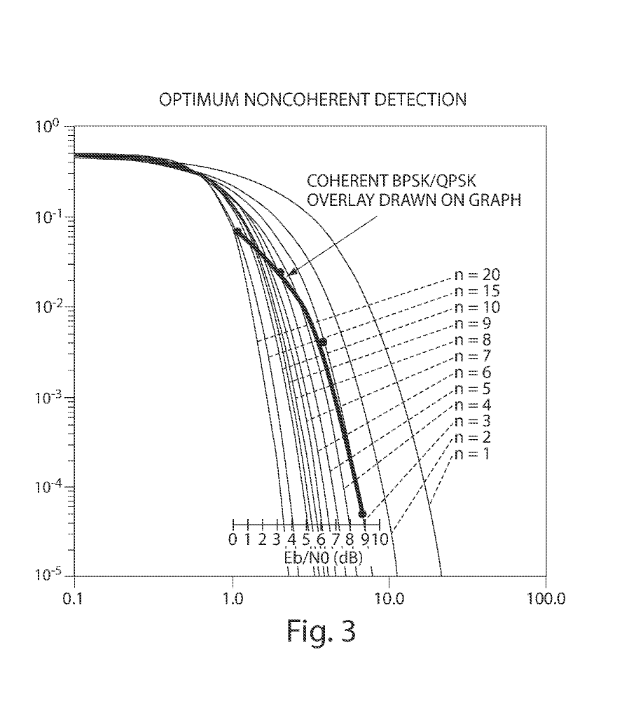

The advantage of spreading through orthogonal sequences (such as Walsh codes) is illustrated in FIG. 3. The figure gives curves for the Eb/NO required to achieve a given bit error rate for non-orthogonal modulation for Walsh Sequence lengths up to 1,000,000 chips. A second curve overlaid onto the figure gives the Eb/NO required for BPSK/QPSK (spread) modulation. Its clear from the figure that utilizing large m Walsh sequences significantly reduce the Eb/NO required for communications. The curve also illustrates the diminishing returns obtained as the Walsh sequences get longer and longer. 1024 chip Walsh sequences achieve a gain of more than 4 dB over conventional QPSK spreading modulation. In addition by increasing the sequences 100 fold to 10 chips long, only about another 1 dB is achieved. Based on this analysis, the preferred modulation uses Walsh sequences of length no longer than 4096 chips. As described above, arbitrarily large processing gains can be achieved by simply repeating Walsh sequences over and over.

For each subband, the bitstream assigned to the subband are Walsh encoded. Walsh codewords of size 32, 1024, 2048 and 4096 chips are used depending on the communication mode. Depending on the mode of operation, the Walsh encoder either maps 5 bits to 32. Walsh chips, 10 bits to 1024 Walsh chips, 11 bits to 2048 Walsh chips, or 12 bits to 4096 Walsh chips. As shown in FIG. 3, subband bits are grouped into groups of m=(5, 10, 11, or 12) bits. Each group is then mapped into a Walsh codeword of size 2 m chips (32, 1024, 2048 or 4096). Depending on the data rate and other requirements for the network mode of operation, Walsh words are repeated many times to increase the processing gain (and effectively lower the data throughput by increasing the energy transmitted per bit). All subbands are processed in exactly the same manner, so that the size of Walsh words and the number of repeats are the same for each subband. If R is defined to be the number of repeats of each Walsh word, then for every m bits assigned to a subband, there are R*2 m Walsh chips generated to be transmitted within the subband. As described above, each of these R*2 m Walsh chips is TRANSEC covered by mapping the chip into a pseudorandomly selected QPSK symbol using TRANSEC supplied pseudorandom bits. For each Walsh data chip, two TRANSEC bits are used to select a QPSK symbol (one of four phases). The Walsh data chip is then used to either keep the QPSK symbol unchanged or to rotated the symbol by 180 degrees.

All the chips within a Walsh codeword are transmitted in the same subband. In general, however, each Walsh word contains more chips than frequencies within a subband. For example, if the band is divided into 64 subbands and modulation uses 2048 chip Walsh words in each subband, then only 16 chips from each of 64 different Walsh Words can be transmitted each chip time. That is, each chip time a QPSK symbol is transmitted on each frequency. With 64 subbands, each subband contains only 16 frequencies, so only 16 Walsh chips from each Walsh word are transmitted. To transmit the entire set of 64 Walsh words (one in each subband), 128 symbol periods are required. If the waveform is generated with FFTs, then 128 FFTs are required to send the 64 Walsh words.

FIG. 2C summarizes the flow of the transmit processes as described above. The receive processes are just the inverse of the processes shown in FIG. 2C. The data stream to be transmitted is first packetized into physical layer packets as shown in block 302. A packet header as shown in block 304 and CRC as shown in block 306 are then added to each packet, and the resulting packet is FEC encoded as shown in block 308 and interleaved as shown in block 310. Next, spread spectrum bandwidth expansion is implemented using very low rate Walsh orthogonal sequences to both encode the symbols and expand the bandwidth as shown in blocks 312 and 314. The Walsh encoding creates a sequence of BPSK chips (1 or −1). TRANSEC is then applied to the chip sequence as shown by multiplier 316. Each chip is multiplied by a unique QPSK TRANSEC symbol. For each Walsh chip, two TRANSEC bits are generated as shown in blocks 320 and 322. The two bits are used to select the pseudorandom the QPSK symbol to be multiplied by the Walsh chip as shown in block 318. Following TRANSEC, the QPSK symbols are mapped into frequency subbands as shown in block 330 as previously explained. A memory buffer is used to store the QPSK symbols as they are mapped into the subbands. At this point, the packet chip sequence is ready to be converted from the frequency domain to the time domain. This operation is performed with an inverse FFT as shown in block 332. The time domain sequence out of the FFT is upconverted and transmitted.

The novel waveform easily supports both transmit and receive frequency excision. Whole subbands as well as individual frequencies can be excised. Transmit excision is important to prevent cosite interference with collocated communications equipment. The concept behind transmit excision is very simple. Those subbands that contain frequencies used by collocated equipment will be zeroed out in the frequency domain prior to the transmit inverse FFT. Thus no signal is transmitted on those selected frequencies. Transmit frequency zeroization can be done either cooperatively or without the knowledge of the receiving terminal. If transmit excision is done without the receiver's knowledge, then the receiver's subband erasure rates will increase on those subbands with excised frequencies. This will reduce the sensitivity of the receiver. The sensitivity reduction depends on how many of the 1024 frequencies are excised. If transmit excision is done cooperatively with the receive terminal, then frequency excision will excise whole subbands at a time, and both the transmitter and receiver will perform a different subband mapping that avoids mapping symbols into excised subbands. In this case, data rate is reduced, but sensitivity is not.

All publications and references cited herein are expressly incorporated herein by reference in their entirety.

Having described the preferred embodiments of the invention, it will now become apparent to one of ordinary skill in the art that other embodiments incorporating their concepts may be used. It is felt therefore that these embodiments should not be limited to disclosed embodiments but rather should be limited only by the spirit and scope of the appended claims.

What is claimed is:

1. A method of receiving a wireless signal comprising:
identifying a signal space for wireless communication, the signal space including a range of frequencies;
receiving a waveform in the signal space, the waveform including a preamble and the waveform organized into a plurality of sub-bands, each one of the plurality of sub-bands defined by one of a plurality of time-frequency tiles characterized by a bandwidth and an integration time;
determining the bandwidth and the integration time of each of the plurality of sub-bands based upon the preamble; and
demodulating a data signal from the waveform using direct sequence spreading for each one of the plurality of sub-bands.

2. The method of claim 1 wherein demodulating the data signal includes using the preamble to determine at least one of an m-ary alphabet size and a data rate used to encode the data signal.

3. The method of claim 1 wherein the preamble includes an indication of the bandwidth and the integration time of at least one of the plurality of time-frequency tiles.

4. The method of claim 1 wherein the preamble includes an indication of one or more of an m-ary alphabet size and a data rate for at least one of the plurality of time-frequency tiles.

5. The method of claim 4 wherein at least one of the m-ary alphabet size and the data rate vary over time.

6. The method of claim 4 wherein the m-ary alphabet size and the data rate vary from burst to burst in a packetized data system.

7. The method of claim 1 wherein the bandwidth and the integration time of all of the time-frequency tiles are selected to provide a plurality of channels each having a coherent time-bandwidth product.

8. The method of claim 1 wherein all of the time-frequency tiles have a common bandwidth and a common integration time.

9. The method of claim 1 further comprising changing at least one of the bandwidth and the integration time between a plurality of bursts of data transmission.

10. The method of claim 1 wherein the signal space is used for ad hoc mobile network communications.

11. The method of claim 1 further comprising descrambling the data signal with a non-linear Transmission Security (TRANSEC) pseudo-noise overlay.

12. The method of claim 1 wherein the waveform carries the data signal at a magnitude substantially within a noise floor for the signal space.

13. A receiver that receives a waveform in a signal space, the waveform including a preamble and the waveform organized into a plurality of sub-bands, each one of the plurality of sub-bands defined by one of a plurality of time-frequency tiles characterized by a bandwidth and an integration time, the receiver adapted to determining the bandwidth and the integration time of each of the plurality of sub-bands based upon the preamble and to demodulate a data signal from the waveform using direct sequence spreading for each one of the plurality of sub-bands.

14. The receiver of claim 13 wherein the receiver demodulates the data signal using the preamble to determine at least one of an m-ary alphabet size and a data rate used to encode the data signal.

15. The receiver of claim 13 wherein the preamble includes an indication of the bandwidth and the integration time of at least one of the plurality of time-frequency tiles.

16. The receiver of claim 13 wherein the preamble includes an indication of one or more of an m-ary alphabet size and a data rate for at least one of the plurality of time-frequency tiles.

17. The receiver of claim 16 wherein at least one of the m-ary alphabet size and the data rate vary over time.

18. The receiver of claim 16 wherein the m-ary alphabet size and the data rate vary from burst to burst in a packetized data system.

19. The receiver of claim 16 wherein the bandwidth and the integration time of all of the time-frequency tiles are selected to provide a plurality of channels each having a coherent time-bandwidth product.

20. The receiver of claim 14 wherein all of the time-frequency tiles have a common bandwidth and a common integration time.
